(19) United States
(12) Patent Application Publication
(10) Pub. No.: US 2017/0351421 A1
(43) Pub. Date: Dec. 7, 2017

(54) METHOD AND APPARATUS FOR CONTROLLING USER INTERFACE ELEMENTS ON A TOUCH SCREEN

(71) Applicant: MOTOROLA SOLUTIONS, INC., CHICAGO, IL (US)

(72) Inventors: HAI-QING HU, CHENGDU (CN); MENG-GE DUAN, CHENGDU (CN); SHI-QIANG LUO, CHENGDU (CN)

(21) Appl. No.: 15/535,425

(22) PCT Filed: Jan. 21, 2015
(86) PCT No.: PCT/CN2015/071246

§ 371 Date: Jun. 13, 2017

(51) Int. Cl. G06F 3/0488; G06F 3/0485; G06F 3/0481

(52) U.S. Cl. CPC G06F 3/04883; G06F 3/0481; G06F 3/0485

(57) ABSTRACT

A method and apparatus for controlling user interface elements is provided herein. During operation, a pressure or velocity of a touch or swipe is measured. Based on the pressure and/or velocity of the touch or swipe, the input will be applied to a particular user interface element from a plurality of user interface elements.

### FIELD OF THE INVENTION

The present invention generally relates to touch-screen devices, and more particularly to a method and apparatus for controlling user interface elements on a touch screen.

### BACKGROUND OF THE INVENTION

Touch-sensitive displays (also known as “touch screens”) are well known in the art. Touch screens are used in many electronic devices to display control buttons, graphics, text, and to provide a user interface through which a user may interact with the device. A touch screen detects and responds to contact on its surface. A device may display one or more control buttons, soft keys, menus, and other user-interface elements on the touch screen. A user may interact with the device by contacting the touch screen at locations corresponding to the user-interface (UI) elements with which they wish to interact.

One problem associated with using touch screens on portable devices is quickly and easily controlling a particular interface element (e.g., a window) when multiple interface elements are visible on the touch screen. This is particularly relevant when windows are nested. If two windows are nested (i.e., one window exists within another window), oftentimes it is difficult to control functions of a particular window. For example, consider two nested windows, both capable of being scrolled. Swiping a finger across the screen of the touch-screen device may scroll one window, when the user intended to scroll another window. A better technique to control elements on a touch screen will lead to a better user experience. Therefore a need exists for a method and apparatus for operating user interface elements on a touch screen that allows a user to better control the user interface elements.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating a general operational environment, according to one embodiment of the present invention;

FIG. 2 illustrates controlling a touch screen.

FIG. 3 is a flow chart showing operation of the device of FIG. 1.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need a method and apparatus for controlling user interface elements is provided herein. During operation, a pressure or velocity of a touch or swipe is measured. Based on the pressure and/or velocity of the touch or swipe, the input will be applied to a particular user interface element from a plurality of user interface elements.

As an example of the above, assume the user contacts a touch screen intending to control a nested user interface (UI) element. The user input may be applied inside or outside of the nested UI elements. An additional measurement of touching pressure and/or the movement speed/direction is performed. If the measurement is above a predetermined threshold, the system applies the user input to a first UI element, otherwise the user input is applied to a second UI element. For example, consider two windows (not necessarily one inside another), when the user vertically swipes on the touch screen with a touch pressure higher than a threshold, the system may scroll a first window, otherwise a second window is scrolled. In a similar manner, when the user vertically swipes on the touch screen with a swipe speed faster than a threshold, the system may scroll a first window, otherwise a second window is scrolled.

It should be noted, that contact with the touch screen by the user may take place inside or outside of a particular window wishing to be controlled. So, for example, a fast swipe outside of a particular window will still control the scrolling of the particular window. It should also be noted that a “window” used herein represents a particular area on a touch screen showing any type of information, and may encompass the whole touch screen. Therefore, a first window may comprise, for example the whole touch screen, while a second window may comprise a second area nested within the first window.

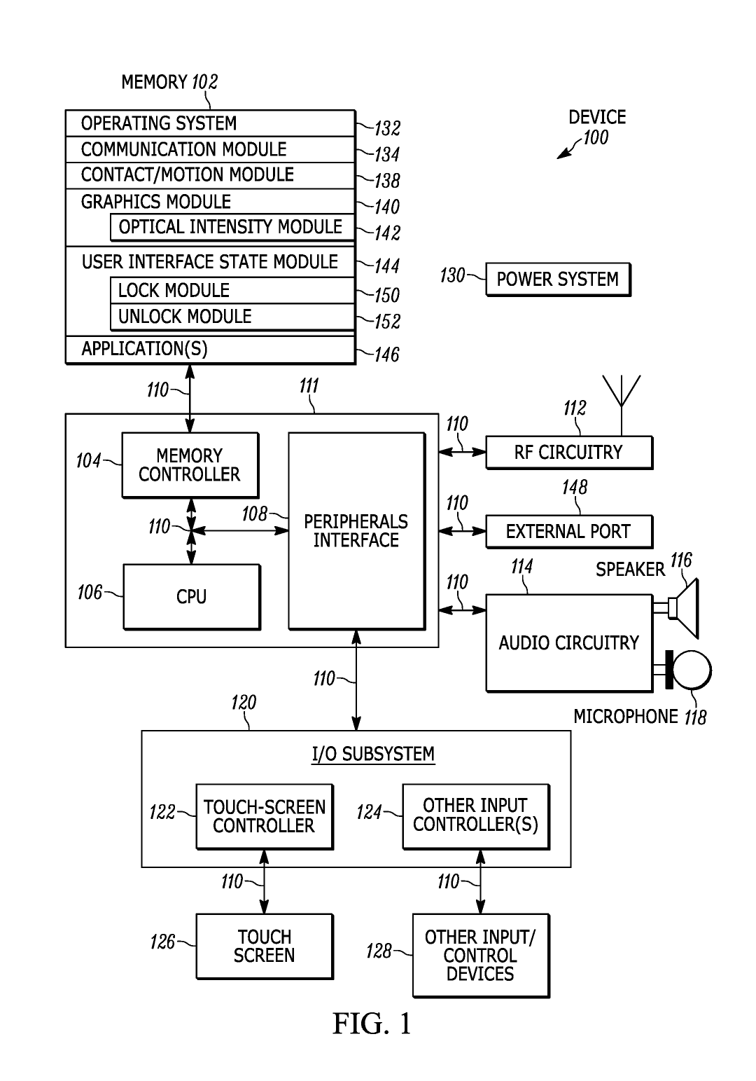

Turning now to the drawings, where like numerals designate like components, FIG. 1 is a block diagram of a portable electronic device that preferably comprises a touch screen 126. The device 100 includes a memory 102, a memory controller 104, one or more processing units (CPU's) 106, a peripherals interface 108, RF circuitry 112, audio circuitry 114, a speaker 116, a microphone 118, an input/output (I/O) subsystem 120, a touch screen 126, other input or control devices 128, and an external port 148. These components communicate over the one or more communication buses or signal lines 110. The device 100 can be any portable electronic device, including but not limited to a handheld computer, a tablet computer, a mobile phone, a police radio, a media player, a personal digital assistant (PDA), or the like, including a combination of two or more of these items. It should be appreciated that the device 100 is only one example of a portable electronic device 100, and that the device 100 may have more or fewer components than shown, or a different configuration of components. The various components shown in FIG. 1 may be implemented in hardware, software or a combination of both hardware and software, including one or more signal processing and/or application specific integrated circuits.

Memory 102 may include high speed random access memory and may also include non-volatile memory, such as one or more magnetic disk storage devices, flash memory devices, or other non-volatile solid state memory devices. In some embodiments, memory 102 may further include storage remotely located from the one or more processors 106, for instance network attached storage accessed via the RF circuitry 112 or external port 148 and a communications network (not shown) such as the Internet, intranet(s), Local Area Networks (LANs), Wide Local Area Networks (WLANs), Storage Area Networks (SANs) and the like, or any suitable combination thereof. Access to the memory 102 by other components of the device 100, such as the CPU 106 and the peripherals interface 108, may be controlled by memory controller 104.

The peripherals interface 108 couples the input and output peripherals of the device to the CPU 106 and the memory 102. The one or more processors 106 run various software programs and/or sets of instructions stored in the memory 102 to perform various functions for the device 100 and to process data.

In some embodiments, the peripherals interface 108, the CPU 106, and the memory controller 104 may be implemented on a single chip, such as a chip 111. In some other embodiments, they may be implemented on separate chips.

The RF (radio frequency) circuitry 112 receives and sends electromagnetic waves. The RF circuitry 112 converts electrical signals to/from electromagnetic waves and communicates with communications networks and other communications devices via the electromagnetic waves. The RF circuitry 112 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 112 may communicate with the networks, such as the Internet, also referred to as the World Wide Web (WWW), an Intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS)), or any other suitable communication protocol, including communication protocols not yet developed as of the filing date of this document.

The audio circuitry 114, the speaker 116, and the microphone 118 provide an audio interface between a user and the device 100. The audio circuitry 114 receives audio data from the peripherals interface 108, converts the audio data to an electrical signal, and transmits the electrical signal to the speaker 116. The speaker converts the electrical signal to human-audible sound waves. The audio circuitry 114 also receives electrical signals converted by the microphone 116 from sound waves. The audio circuitry 114 converts the electrical signal to audio data and transmits the audio data to the peripherals interface 108 for processing. Audio data may be may be retrieved from and/or transmitted to the memory 102 and/or the RF circuitry 112 by the peripherals interface 108. In some embodiments, the audio circuitry 114 also includes a headset jack (not shown). The headset jack provides an interface between the audio circuitry 114 and removable audio input/output peripherals, such as output-only headphones or a headset with both output (headphone for one or both ears) and input (microphone).

The I/O subsystem 120 provides the interface between input/output peripherals on the device 100, such as the touch screen 126 and other input/control devices 128, and the peripherals interface 108. The I/O subsystem 120 includes a touch-screen controller 122 and one or more input controllers 124 for other input or control devices. The one or more input controllers 124 receive/send electrical signals from/to other input or control devices 128. The other input/control devices 128 may include physical buttons (e.g., push buttons, rocker buttons, etc.), dials, slider switches, sticks, and so forth.

The touch screen 126 provides both an output interface and an input interface between the device and a user. The touch-screen controller 122 receives/sends electrical signals from/to the touch screen 126. The touch screen 126 displays visual output to the user. The visual output may include text, graphics, video, and any combination thereof. Some or all of the visual output may correspond to user-interface objects, further details of which are described below.

The touch screen 126 also accepts input from the user based on haptic and/or tactile contact. The touch screen 126 forms a touch-sensitive surface that accepts user input. The touch screen 126 and the touch screen controller 122 (along with any associated modules and/or sets of instructions in the memory 102) detects contact (and any movement or break of the contact) on the touch screen 126 and converts the detected contact into interaction with user-interface objects, such as one or more windows, that are displayed on the touch screen. In an exemplary embodiment, a point of contact between the touch screen 126 and the user corresponds to one or more finger digits of the user. The touch screen 126 may use LCD (liquid crystal display) technology, or LPD (light emitting polymer display) technology, although other display technologies may be used in other embodiments.

The touch screen 126 and touch screen controller 122 may detect contact and any movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 126. The touch-sensitive display may be analogous to the multi-touch sensitive tablets described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1. The touch screen 126 displays visual output from the portable device, whereas touch sensitive tablets do not provide visual output. The touch screen 126 may have a resolution in excess of 100 dpi. In an exemplary embodiment, the touch screen 126 may have a resolution of approximately 168 dpi. The user may make contact with the touch screen 126 using any suitable object or appendage, such as a stylus, finger, and so forth.

In some embodiments, in addition to the touch screen, the device 100 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from the touch screen 126 or an extension of the touch-sensitive surface formed by the touch screen 126.

The device 100 also includes a power system 130 for powering the various components. The power system 130 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

In some embodiments, the software components include an operating system 132, a communication module (or set of instructions) 134, an electronic contact module (or set of instructions) 138, a graphics module (or set of instructions) 140, a user interface state module (or set of instructions) 144, and one or more applications (or set of instructions) 146.

The operating system 132 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module 134 facilitates communication with other devices over one or more external ports 148 and also includes various software components for handling data received by the RF circuitry 112 and/or the external port 148. The external port 148 (e.g., Universal Serial Bus (USB), FIREWIRE, etc.) is adapted for coupling directly to other devices or indirectly over a network (e.g., the Internet, wireless LAN, etc.).

The contact/contact module 138 detects contact with the touch screen 126, in conjunction with the touch-screen controller 122. The contact/contact module 138 includes various software components for performing various operations related to detection of contact with the touch screen 126, such as determining if contact has occurred, determining a pressure of any contact with the touch screen, determining if there is movement of the contact and tracking the movement across the touch screen, and determining if the contact has been broken (i.e., if the contact has ceased). Determining movement of the point of contact may include determining speed (magnitude), velocity (magnitude and direction), and/or an acceleration (including magnitude and/or direction) of the point of contact. In some embodiments, the contact/contact module 138 and the touch screen controller 122 also detects contact on the touchpad.

The graphics module 140 includes various known software components for rendering and displaying graphics on the touch screen 126. Note that the term “graphics” includes any object that can be displayed to a user, including without limitation text, web pages, icons (such as user-interface objects including soft keys), digital images, videos, animations and the like.

In some embodiments, the graphics module 140 includes an optical intensity module 142. The optical intensity module 142 controls the optical intensity of graphical objects, such as user-interface objects, displayed on the touch screen 126. Controlling the optical intensity may include increasing or decreasing the optical intensity of a graphical object. In some embodiments, the increase or decrease may follow predefined functions.

The user interface state module 144 controls the user interface state of the device 100. The user interface state module 144 may include a lock module 150 and an unlock module 152. The lock module detects satisfaction of any of one or more conditions to transition the device 100 to a user-interface lock state and to transition the device 100 to the lock state. The unlock module detects satisfaction of any of one or more conditions to transition the device to a user-interface unlock state and to transition the device 100 to the unlock state.

The one or more applications 146 can include any applications installed on the device 100, including without limitation, a browser, address book, contact list, email, instant messaging, word processing, keyboard emulation, widgets, JAVA-enabled applications, encryption, digital rights management, voice recognition, voice replication, location determination capability (such as that provided by the global positioning system (GPS)), a music player (which plays back recorded music stored in one or more files, such as MP3 or AAC files), etc.

In some embodiments, the device 100 may include the functionality of an MP3 player, such as an iPod (trademark of Apple Computer, Inc.). The device 100 may, therefore, include a 36-pin connector that is compatible with the iPod. In some embodiments, the device 100 may include one or more optional optical sensors (not shown), such as CMOS or CCD image sensors, for use in imaging applications.

In some embodiments, the device 100 is a device where operation of a predefined set of functions on the device is performed exclusively through the touch screen 126 and, if included on the device 100, the touchpad. By using the touch screen and touchpad as the primary input/control device for operation of the device 100, the number of physical input/control devices (such as push buttons, dials, and the like) on the device 100 may be reduced. In one embodiment, the device 100 includes the touch screen 126, the touchpad, a push button for powering the device on/off and locking the device, a volume adjustment rocker button and a slider switch for toggling ringer profiles. The push button may be used to turn the power on/off on the device by depressing the button and holding the button in the depressed state for a predefined time interval, or may be used to lock the device by depressing the button and releasing the button before the predefined time interval has elapsed. In an alternative embodiment, the device 100 also may accept verbal input for activation or deactivation of some functions through the microphone 118.

The predefined set of functions that are performed exclusively through the touch screen and the touchpad include navigation between user interfaces. In some embodiments, the touchpad, when touched by the user, navigates the device 100 to a main, home, or root menu from any user interface that may be displayed on the device 100. In such embodiments, the touchpad may be referred to as a “menu button.” In some other embodiments, the menu button may be a physical push button or other physical input/control device instead of a touchpad.

The device 100 may have a plurality of user interface states. A user interface state is a state in which the device 100 responds in a predefined manner to user input. In some embodiments, the plurality of user interface states includes a user-interface lock state and a user-interface unlock state. In some embodiments, the plurality of user interface states includes states for a plurality of applications.

As is known in the art, touch screen 126 is capable of displaying UI elements which represents places where the user may interact, the interaction of which causes contact module 138 to instruct CPU 106 to execute a particular function, application, or program. UI elements may sometimes be referred to as controls or widgets. These controls or widgets may take any form to execute any function, some of which are described below:

Window—UI elements may take the form of a paper-like rectangle that represents a “window” into a document, form, or design area.

Text box—UI elements may take the form of a box in which to enter text or numbers.

Button—UI elements may take the form of an equivalent to a push-button as found on mechanical or electronic instruments. Interaction with UI elements in this form serve to control functions on device 100. For example UI element 1 may serve to control a volume function for speaker 116, while UI element 2 may serve to key microphone 118.

Hyperlink—UI elements may take the form of text with some kind of indicator (usually underlining and/or color) that indicates that clicking it will take one to another screen or page.

Drop-down list or scroll bar—UI elements may take the form of a list of items from which to select. The list normally only displays items when a special button or indicator is clicked.

List box—UI elements may take the form of a user-interface widget that allows the user to select one or more items from a list contained within a static, multiple line text box.

Combo box—UI elements may take the form of a combination of a drop-down list or list box and a single-line textbox, allowing the user to either type a value directly into the control or choose from the list of existing options.

Check box—UI elements may take the form of a box which indicates an “on” or “off” state via a check mark or a cross Z. Sometimes can appear in an intermediate state (shaded or with a dash) to indicate mixed status of multiple objects.

Radio button—UI elements may take the form of a radio button, similar to a check-box, except that only one item in a group can be selected. Its name comes from the mechanical push-button group on a car radio receiver. Selecting a new item from the group's buttons also deselects the previously selected button.

Cycle button or control knob—UI elements may take the form of a button or knob that cycles its content through two or more values, thus enabling selection of one from a group of items.

Datagrid—UI elements may take the form of a spreadsheet-like grid that allows numbers or text to be entered in rows and columns.

Switch—UI elements may take the form of a switch such that activation of a particular UI element toggles a device state. For example, UI element 1 may take the form of an on/off switch that controls power to device 100.

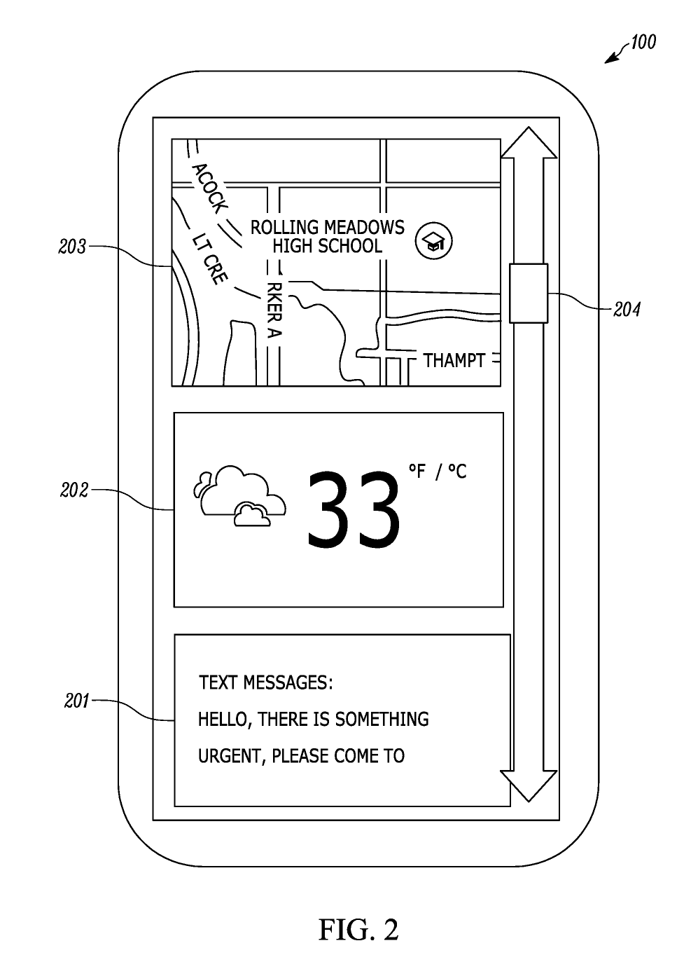

As described above, one problem associated with using touch screens 126 on portable devices is quickly and easily controlling UI elements (e.g., a window) when multiple UI elements are visible on the touch screen. This is particularly relevant when windows are nested. In order to address the above-mentioned need module 138 will detect a trigger. The trigger preferably comprises a pressure or velocity of a touch or swipe (a swipe comprises a movement of the fingers across a touch screen). Based on the pressure and/or velocity of the touch or swipe, contact module 138 will instruct CPU 106 to execute a particular function, application, or program of a UI element. This is illustrated in FIG. 2.

As shown in FIG. 2, device 100 has three windows 201-203 displayed on a touch screen. The entire touch screen itself may be thought of as a fourth window. Window 201 comprises a window displaying a text message, window 202 comprises a window showing current weather conditions, and window 203 comprises a window showing a map. Each window 201-203 is capable of being scrolled individually of the other windows. In addition to scrolling each window 201-203, the touch screen display itself is capable of being scrolled so that other windows outside the current field of view (not shown) may be accessed by scrolling the touch-screen display as indicated by scroll bar 204.

In order to scroll a particular window (showing additional content for the window) the pressure and/or velocity of the scroll will be taken into consideration by the contact module 138. Unlike the prior art, the particular window being scrolled will be determined by the velocity and/or the pressure of the swipe. As discussed above, the swipe does not necessarily need to take place within the window being scrolled. An example is given below in Table 1.

TABLE 1
Window Control Example

| | | Evaluation | |
|---|---|---|---|
| User Input | Trigger | Result | Functions |
| User vertically | Swiping | Fast swiping | Scroll the text message |
| swipes up on the | velocity | | down to display the |
| “text message” | | | content on the next page |
| widget | | Slow swiping | On the touch-screen |
| | | | display, scroll the |
| | | | vertical layout and move |
| | | | the widgets out of |
| | | | current view and move |
| | | | the next a few widgets |
| | | | into the current view. |
| User vertically | Touch | Intensively | On the touch-screen |
| swipes down on | pressure | heavy press | display, scroll the |
| the map widget | | | vertical layout and move |
| | | | the widgets out of |
| | | | current view and move |
| | | | the next a few widgets |
| | | | into the current view. |
| | | light weight | Move the above area of |
| | | press | the map into the map |
| | | | widget view |
| User swipes | Touch | Fast swiping | Scroll a window |
| anywhere on the | Velocity | | associated with fast |
| touch screen | | | swiping |
| | | Slow swiping | Scroll the touch screen |

As is evident, a swipe velocity, or a swipe pressure may be associated with what window to scroll so that, for example a fast swipe scrolls a first window, while a slow swipe scrolls the scrolling of the entire touch screen (fourth window). Alternatively, a fast swipe scrolls a first window, while a slow swipe scrolls a second window. Alternatively, a heavy swipe scrolls a first window, while a swipe scroll scrolls the touch screen itself (fourth window). Alternatively, a heavy swipe scrolls a first window while a light swipe scrolls a second window.

The swipe may or may not need to be within a particular window that scrolls. So, for example, if two windows exist on a touch screen, a slow swipe anywhere on the touch screen may control scrolling of a first window, while a fast swipe anywhere on the touch screen may control scrolling of a second window. In a similar manner, a heavy swipe anywhere on the touch screen may control scrolling of a first window, while a light swipe anywhere on the touch screen may control scrolling of a second window.

A slow swipe may comprise any swipe lower than a predetermined threshold, for example, 2 cm/second, while a fast swipe may comprise any swipe faster that the predetermined threshold. A light swipe may comprise any swipe made having a pressure less than a predetermined threshold, e.g., ½ Newton, while a heavy swipe may comprise any swipe greater than the predetermined threshold,

Additionally, while the above was described with respect to scrolling a window or touch screen, in alternate embodiments of the present invention other UI elements besides windows may be controlled accordingly. So for example, a slow swipe anywhere on the touch screen may control of a first widget, while a fast swipe anywhere on the touch screen may control a second widget. In a similar manner, a heavy swipe anywhere on the touch screen may control of a first widget, while a light swipe anywhere on the touch screen may control a second widget. So, for example, a slow scroll upward may control a volume widget to increase a volume while a fast scroll upward may scroll the touch screen accordingly.

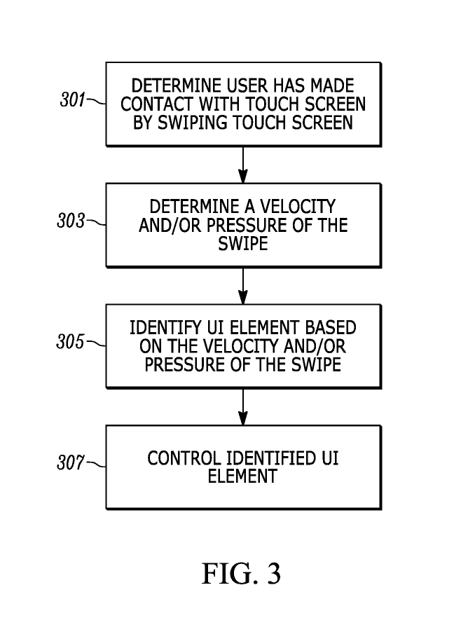

FIG. 3 is a flow chart showing operation of the device of FIG. 1. More particularly, the flow chart of FIG. 3 illustrates a method for controlling user interface elements on a touch screen. The logic flow begins at step 301 where contacts module 138 determines that a user had made contact to the touch screen by swiping the touch screen. Contact module 138 then determines a velocity and/or pressure of the swipe (step 303), and identifies a user interface element from a plurality of user interface elements based on the velocity and/or pressure of the swipe (step 305). Finally, processor 106 controls the identified user interface element accordingly (step 307).

As discussed above, the step of determining that the user has made contact to the touch screen by swiping the touch screen may comprise the step of determining that the user has made contact to the touch screen by moving one of the user's fingers across the touch screen. Additionally, the step of identifying the user interface element may comprise the step of identifying a window from a plurality of open windows, wherein the windows may be nested and one window may comprise a complete visual surface of the touch screen. Additionally, the step of detecting that the user has made contact to the touch screen may comprise the step of detecting that the user has made contact to the touch screen outside the identified window. Finally, the step of controlling the identified user interface element may comprise the step of scrolling the identified window.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for controlling user interface elements on a touch screen, the method comprising the steps of:
determining that a user had made contact to the touch screen by swiping the touch screen;
determining a velocity and/or pressure of the swipe;
identifying a user interface element from a plurality of user interface elements based on the velocity and/or pressure of the swipe; and
controlling the identified user interface element.

2. The method of claim 1 wherein the step of determining that the user has made contact to the touch screen by swiping the touch screen comprises the step of determining that the user has made contact to the touch screen by moving a finger across the touch screen.

3. The method of claim 2 wherein the step of identifying the user interface element comprises the step of identifying a window from a plurality of open windows.

4. The method of claim 3 wherein the step of detecting that the user has made contact to the touch screen comprises the step of detecting that the user has made contact to the touch screen outside the identified window.

5. The method of claim 4 wherein the step of controlling the identified window comprises the step of scrolling the identified window.

6. An apparatus comprising:
a touch screen;
a contact module determining that a user had made contact to the touch screen by swiping the touch screen, determining a velocity and/or pressure of the swipe, identifying a user interface element from a plurality of user interface elements based on the velocity and/or pressure of the swipe; and
a processor controlling the identified user interface element.

7. The apparatus of claim 6 wherein the swipe comprises a movement of the user's finger across the touch screen.

8. The apparatus of claim 7 wherein the user interface element comprises a window and the plurality of user interface elements comprise a plurality of windows.

9. The apparatus of claim 8 wherein the contact comprises a swipe outside the identified window.

10. The apparatus of claim 9 wherein controlling comprises scrolling.

11. The apparatus of claim 9 wherein the identified window comprises a complete visual surface of the touch screen.

12. The apparatus of claim 11 wherein the plurality of windows are nested.
